(19) United States
(12) Patent Application Publication
(10) Pub. No.: US 2015/0292184 A1
(43) Pub. Date: Oct. 15, 2015

(54) LIQUID-PRESSURE CONTROL DEVICE

(71) Applicant: KAWASAKI JUKOGYO KABUSHIKI KAISHA, Kobe-shi, Hyogo (JP)

(72) Inventors: Akihiro Kondo, Nishinomiya-shi (JP); Makoto Ito, Kobe-shi (JP); Kazuto Fujiyama, Kobe-shi (JP); Koji Sakashita, Kako-gun (JP)

(21) Appl. No.: 14/439,900

(22) PCT Filed: Oct. 30, 2013
(86) PCT No.: PCT/JP2013/006426

§ 371 Date: Apr. 30, 2015

(30) Foreign Application Priority Data
Oct. 30, 2012 (JP) 2012-239300

(51) Int. Cl. E02F 9/22; F15B 13/02; F15B 13/042; F15B 11/08

(52) U.S. Cl. CPC E02F 9/2228; F15B 11/08; F15B 13/026; F15B 13/0426

(57) ABSTRACT

A liquid-pressure control device includes a switching valve, a manipulation valve, a first back pressure output mechanism, and a second shuttle valve. When a manipulation lever is manipulated, the manipulation valve outputs a first output pressure corresponding to a manipulation amount of the manipulation lever. When a predetermined operation state is satisfied, the first back pressure output mechanism outputs a first back pressure. The first output pressure is input as a first pilot pressure to the switching valve, and the first back pressure is input as a second pilot pressure to the switching valve. The switching valve supplies a liquid pressure to a boom cylinder at a flow rate corresponding to a differential pressure between the first and second pilot pressures.

### TECHNICAL FIELD

The present invention relates to a liquid-pressure control device configured to supply a pressure liquid, discharged from a liquid-pressure pump, to an actuator to drive the actuator, and a construction machinery including the liquid-pressure control device.

### BACKGROUND ART

A construction machinery, such as a hydraulic excavator, includes a plurality of hydraulic actuators and can drive the hydraulic actuators to move various components, such as booms, arms, buckets, revolve devices, and travel devices, thereby performing various work and the like. To drive the hydraulic actuators, the construction machinery includes a hydraulic control device as disclosed in PTL 1, for example.

The hydraulic control device described in PTL 1 includes a hydraulic pump and supplies an oil pressure, discharged from the hydraulic pump, to an actuator to drive the actuator. The hydraulic control device includes a switching valve (having a flow rate control function) and a manipulation valve, and the switching valve is located between the hydraulic pump and the actuator. The switching valve is configured to adjust the flow rate of the oil pressure, supplied to the actuator, in accordance with the position of a spool. The manipulation valve is connected to the switching valve and is provided with a manipulation lever.

An electromagnetic proportional control valve and a controller are provided between the manipulation lever and the switching valve, and a manipulation signal corresponding to a manipulation amount of the manipulation lever is input to the controller. The controller drives the electromagnetic proportional control valve in accordance with this signal, so that a first or second pilot pressure corresponding to the manipulation lever is output. These two pilot pressures are input to the switching valve, and the spool moves to a position corresponding to the input pilot pressures. Therefore, the oil pressure is supplied to the actuator in a direction corresponding to a manipulation direction of the manipulation lever at a flow rate corresponding to the manipulation amount of the manipulation lever and a load pressure of the actuator.

### CITATION LIST

### Patent Literature

PTL 1: Japanese Laid-Open Patent Application Publication No. 64-6501

### SUMMARY OF INVENTION

### Technical Problem

As described above, the hydraulic control device described in PTL 1 is used in a hydraulic machinery, such as a construction machinery, including a plurality of actuators. Operating conditions, such as manipulations, temperatures, and driving states, vary. For example, the viscosity of the pressure liquid supplied to the actuator differs between a case where the construction machinery is used under a low-temperature environment and a case where the construction machinery is used under a high-temperature environment. Even in a case where the manipulation amount of the manipulation lever is the same between these cases, the flow rate of the pressure liquid supplied to the actuator differs therebetween. Therefore, in a case where the switching valve is set such that the flow rate with respect to the manipulation amount is high for coping with the low-temperature environment, a large amount of pressure liquid flows to the actuator for the operation of the actuator under the high-temperature environment, and this may cause an impact.

When disconnection or a connection failure regarding the manipulation signal from the manipulation lever, disconnection or a connection failure regarding a stick or electric wire of the electromagnetic proportional control valve, an operation failure of the controller, or the like occurs, the switching valve cannot be manipulated even by manipulating the manipulation lever.

In the construction machinery configured such that a plurality of actuators are provided and the switching valve does not include a pressure compensation mechanism, when a plurality of manipulation levers are manipulated, the flow rate of the liquid flowing to the actuator whose load is low becomes excessive. Therefore, a restrictor which selectively operates in accordance with the type of the manipulation needs to be provided upstream of the switching valve whose load is lower. This is because in the case of manipulating the plurality of manipulation levers, the manipulation amount of the manipulation lever of the actuator whose load is low needs to be adjusted to be small in accordance with the magnitude of the load, but such manipulation is difficult for an inexperienced operator.

An object of the present invention is to provide a liquid-pressure control device capable of adjusting the flow rate of a pressure liquid flowing to an actuator in accordance with an operation state.

### Solution to Problem

A liquid-pressure control device of the present invention is a liquid-pressure control device configured to supply a pressure liquid, discharged from a liquid-pressure pump driven by an engine or an electric motor, to an actuator to drive the actuator, the liquid-pressure control device including: a manipulation valve including a manipulation lever and configured to output an output pressure corresponding to a manipulation amount of the manipulation lever when the manipulation lever is manipulated; a back pressure output mechanism configured to output a back pressure when a predetermined operation state is satisfied; and a flow control valve to which the output pressure output from the manipulation valve is input as a first pilot pressure and the back pressure is input as a second pilot pressure, the flow control valve being configured to supply the pressure liquid to the actuator at a flow rate corresponding to a differential pressure between the first pilot pressure and the second pilot pressure.

According to the present invention, when a predetermined operation state is satisfied, the back pressure is input as the second pilot pressure to the flow control valve. With this, the differential pressure between the first pilot pressure and the second pilot pressure can be changed in accordance with the operation state without changing the manipulation amount of the manipulation lever. To be specific, the flow rate of the liquid pressure flowing to the actuator can be adjusted in accordance with the operation state without changing the manipulation amount of the manipulation lever.

In the above invention, it is preferable that: the operation state include at least one of a manipulation state of the manipulation lever, a revolution of the engine, a temperature of the pressure liquid, and a load acting on the actuator; and the back pressure output mechanism output the back pressure corresponding to the operation state.

According to the above configuration, efficient driving corresponding to the operation state can be realized.

In the above invention, it is preferable that: a set of the flow control valve and the manipulation valve be provided for each of a plurality of actuators including the actuator; and the manipulation state of the manipulation lever include a state where at least two of the manipulation levers of the manipulation valves are manipulated.

According to the above configuration, when a plurality of manipulation levers are manipulated, any of the flow control valves can adjust the flow rate of the pressure liquid flowing to the actuator corresponding to the flow control valve. For example, by reducing the flow rate of the pressure liquid flowing to the actuator whose load is low, the pressure liquid flows to the actuator whose load is high, so that the driving speed of the actuator whose load is high can be prevented from extremely decreasing.

In the above invention, it is preferable that: the back pressure output mechanism include a control device and an electromagnetic control valve; the control device output to the electromagnetic control valve a command signal corresponding to the operation state; and the electromagnetic control valve output the back pressure corresponding to the command signal.

According to the above configuration, since the electromagnetic control valve is adopted, the operability can be finely tuned. Further, since the tuning work of the operability can be performed only by the setting of the control device, the tuning work of the liquid-pressure control device is facilitated, and a development time of the liquid-pressure control device can be shortened.

In the above invention, it is preferable that the electromagnetic control valve be a normally closed valve.

According to the above configuration, even when a failure occurs where the current does not flow to the electromagnetic control valve, the electromagnetic control valve can be prevented from being left open. Thus, fail-safe of the liquid-pressure control device can be realized.

In the above invention, it is preferable that: the liquid-pressure control device further include a high pressure selective valve configured to select a higher one of two input pressures to output the selected input pressure as the second pilot pressure to the flow control valve; the manipulation valve output a first output pressure and a second output pressure, which correspond to the manipulation amount of the manipulation lever, as the output pressure in accordance with a manipulation direction of the manipulation lever; the first output pressure be input as the first pilot pressure to the flow control valve; and the second output pressure and the back pressure be input as the two input pressures to the high pressure selective valve.

According to the above configuration, in a case where the second output pressure is output by manipulating the manipulation lever, the second output pressure is input as the second pilot pressure to the flow control valve instead of the back pressure. With this, the liquid pressure can be supplied from the flow control valve to the actuator at a flow rate corresponding to the second output pressure.

In the above invention, it is preferable that the back pressure output mechanism utilize the first output pressure as a pressure source and reduce the first output pressure to generate the back pressure.

According to the above configuration, the back pressure can be prevented from being output from the back pressure output mechanism when the manipulation lever of the manipulation valve is not manipulated. With this, even if the back pressure output mechanism malfunctions when the manipulation lever of the manipulation valve is not manipulated, the spool does not move. Therefore, the fail-safe of the liquid-pressure control device can be realized. Further, a maximum output pressure from the electromagnetic proportional valve is set to be lower than a supply pressure of the electromagnetic proportional valve, so that even if the electromagnetic control valve keeps on operating at a maximum opening degree, the flow control valve can be moved to a certain position, and therefore, the pressure liquid can be supplied to the actuator. With this, it is possible to prevent a case where the liquid-pressure control device does not operate by the failure of the electromagnetic control valve.

In the above invention, it is preferable that: the liquid-pressure control device further include a back pressure switching valve configured to input the back pressure, output from the electromagnetic control valve, to the flow control valve as one of the first pilot pressure and the second pilot pressure: the manipulation valve output one of the first output pressure and the second output pressure as the output pressure in accordance with a manipulation direction of the manipulation lever; the first output pressure be input as the first pilot pressure to the flow control valve; the second output pressure be input as the second pilot pressure to the flow control valve; when the first output pressure is output from the manipulation valve, the back pressure switching valve input the back pressure as the second pilot pressure to the flow control valve; and when the second output pressure is output from the manipulation valve, the back pressure switching valve input the back pressure as the first pilot pressure to a switching valve.

According to the above configuration, the back pressure output from the electromagnetic control valve can be input by the back pressure switching valve to the flow control valve as the first pilot pressure or the second pilot pressure. With this, the electromagnetic control valve does not have to be provided at each of the first pilot pressure side and the second pilot pressure side. With this, the number of electromagnetic control valves can be reduced, and the manufacturing cost of the liquid-pressure control device can be reduced.

In the above invention, it is preferable that the electromagnetic control valve reduce a higher one of the first output pressure and the second output pressure to generate the back pressure.

According to the above configuration, the back pressure can be prevented from being output from the electromagnetic control valve when the manipulation lever of the manipulation valve is not manipulated. With this, even if the electromagnetic control valve malfunctions when the manipulation lever of the manipulation valve is not manipulated, the spool does not move. Therefore, the fail-safe of the liquid-pressure control device can be realized. Further, even if the electromagnetic control valve keeps on operating at the maximum opening degree, the flow control valve can be moved to a certain position, and therefore, the pressure liquid can be supplied to the actuator. With this, it is possible to prevent a case where the liquid-pressure control device does not operate by the failure of the electromagnetic control valve.

### Advantageous Effects of Invention

According to the present invention, the flow rate of the liquid pressure flowing to the actuator can be adjusted in accordance with the operating condition.

The above object, other objects, features, and advantages of the present invention will be made clear by the following detailed explanation of preferred embodiments with reference to the attached drawings.

### BRIEF DESCRIPTION OF DRAWINGS

FIG. 1 is a side view showing a hydraulic excavator including a liquid-pressure control device of an embodiment of the present invention.

FIG. 2 is a circuit diagram showing a liquid-pressure circuit of the liquid-pressure control device of Embodiment 1.

FIG. 3 is an enlarged circuit diagram showing a part of the liquid-pressure circuit of the liquid-pressure control device of FIG. 2.

FIG. 4A shows time-series changes of a manipulation amount of a manipulation lever of a boom valve unit. FIG. 4B shows time-series changes of a differential pressure of a spool of the boom valve unit. FIG. 4C shows time-series changes of a flow rate of a pressure liquid flowing through the boom cylinder.

FIG. 5A shows time-series changes of the manipulation amount of a manipulation lever 37 of an arm valve unit. FIG. 5B shows time-series changes of a differential pressure dp of a spool of the arm valve unit. FIG. 5C shows time-series changes of the flow rate of the pressure liquid flowing through an arm cylinder.

FIG. 6 is a circuit diagram showing the liquid-pressure circuit of the liquid-pressure control device of Embodiment 2.

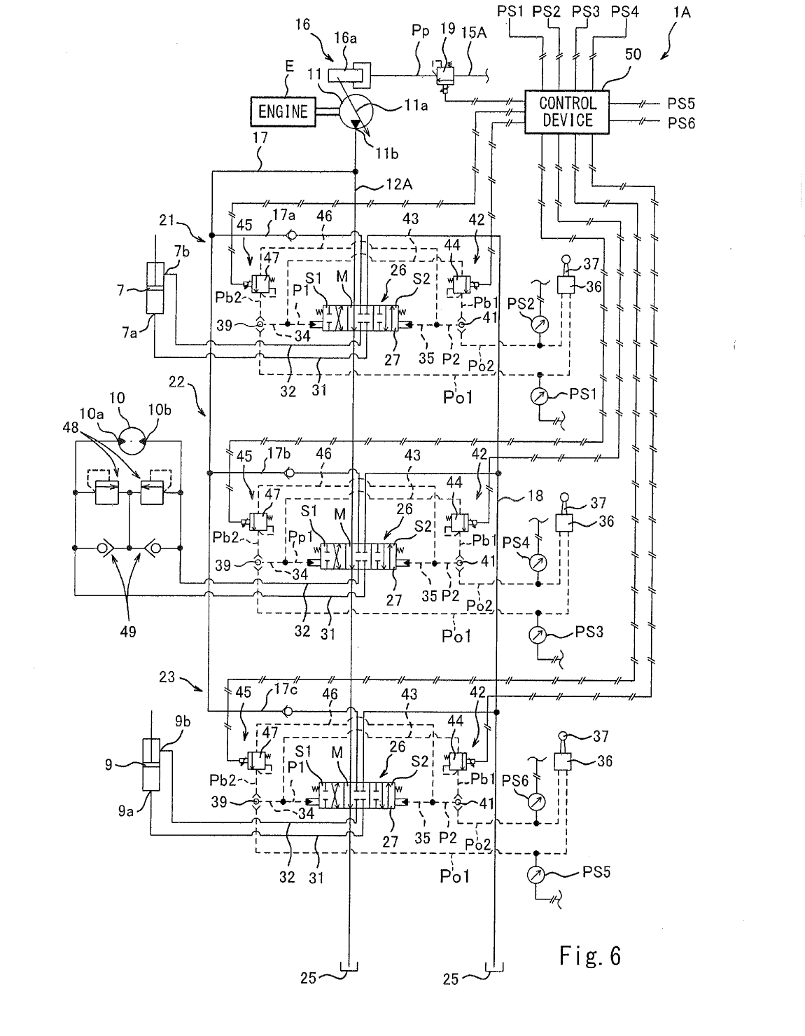

FIG. 7 is a circuit diagram showing the liquid-pressure circuit of the liquid-pressure control device of Embodiment 3.

FIG. 8 is an enlarged circuit diagram showing a part of the liquid-pressure circuit of the liquid-pressure control device of FIG. 7.

FIG. 9 is an enlarged circuit diagram showing a part of the liquid-pressure circuit of the liquid-pressure control device of Embodiment 4.

### DESCRIPTION OF EMBODIMENTS

Hereinafter, the configurations of liquid-pressure control devices 1 and 1A to 1C according to Embodiments 1 to 4 of the present invention and a hydraulic excavator 2 including the liquid-pressure control device will be explained in reference to the drawings. The directions described in the embodiments are used for convenience of explanation and do not suggest that the arrangements, directions, and the like of components regarding the structures of the liquid-pressure control devices 1 and 1A to 1C and the hydraulic excavator 2 are limited to such directions. Each of the structures of the liquid-pressure control devices 1 and 1A to 1C and the hydraulic excavator 2 is just one embodiment of the present invention, and the present invention is not limited to the embodiments. Additions, deletions, and modifications may be made within the scope of the present invention.

### Embodiment 1

### Hydraulic Excavator

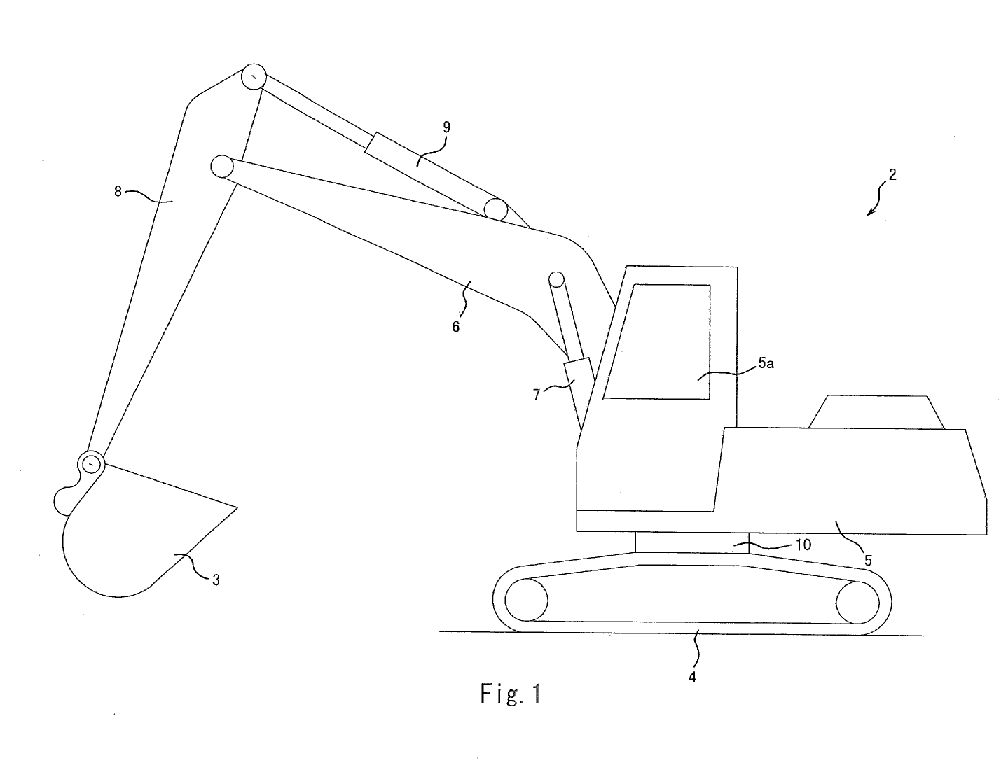

As shown in FIG. 1, the hydraulic excavator 2 that is a construction machinery can perform various work, such as excavation and carriage, by an attachment, such as a bucket 3, attached to a tip end portion of the hydraulic excavator 2. The hydraulic excavator 2 includes a travel device 4, such as a crawler, and a revolving super structure 5 is mounted on the travel device 4 so as to be revolvable. The revolving super structure 5 is configured to be revolvable by a below-described revolution motor 10 and is provided with a driver's seat 5a on which a driver gets.

A boom 6 extending forward and obliquely upward from the revolving super structure 5 is provided at the revolving super structure 5 so as to be swingable in an upper-lower direction. A boom cylinder 7 is provided at the boom 6 and the revolving super structure 5. By expanding or contracting the boom cylinder 7, the boom 6 swings relative to the revolving super structure 5. An arm 8 extending forward and obliquely downward is provided at a tip end portion of the boom 6, which swings as above, so as to be swingable in a front-rear direction. An arm cylinder 9 is provided at the boom 6 and the arm 8. By expanding or contracting the arm cylinder 9, the arm 8 swings relative to the boom 6. Further, the bucket 3 is provided at a tip end portion of the arm 8 so as to be swingable in the front-rear direction. Although details are omitted, a bucket cylinder is provided at the bucket 3, and by expanding or contracting the bucket cylinder, the bucket 3 swings in the front-rear direction.

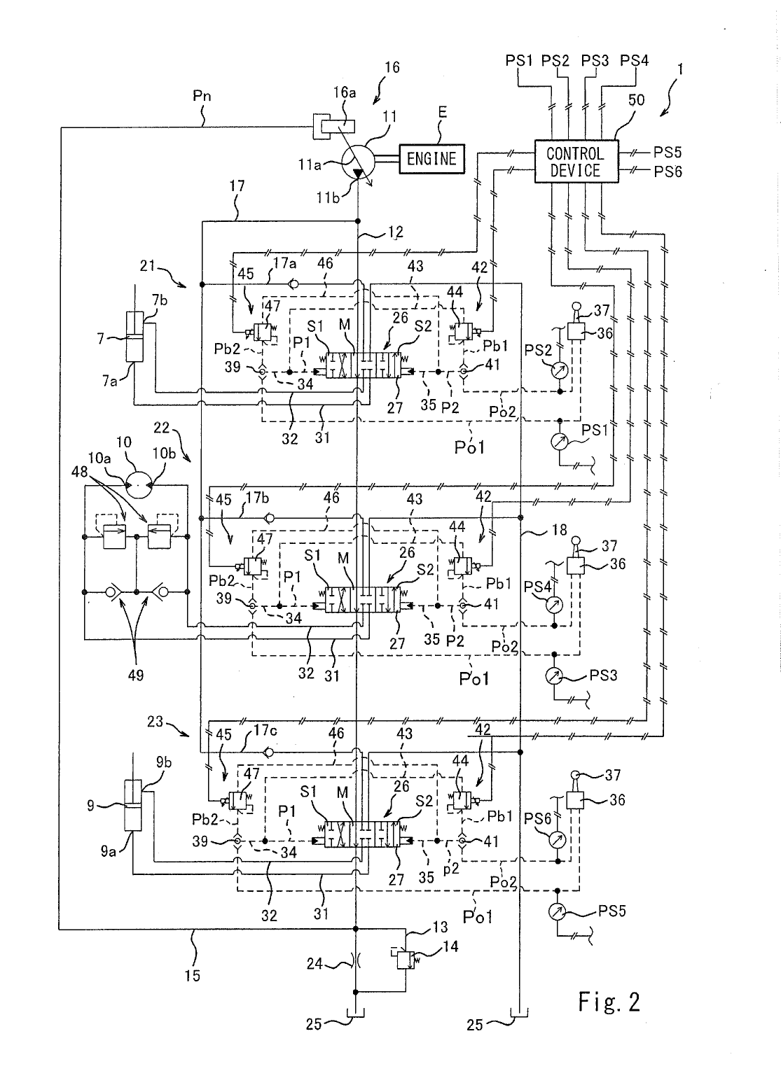

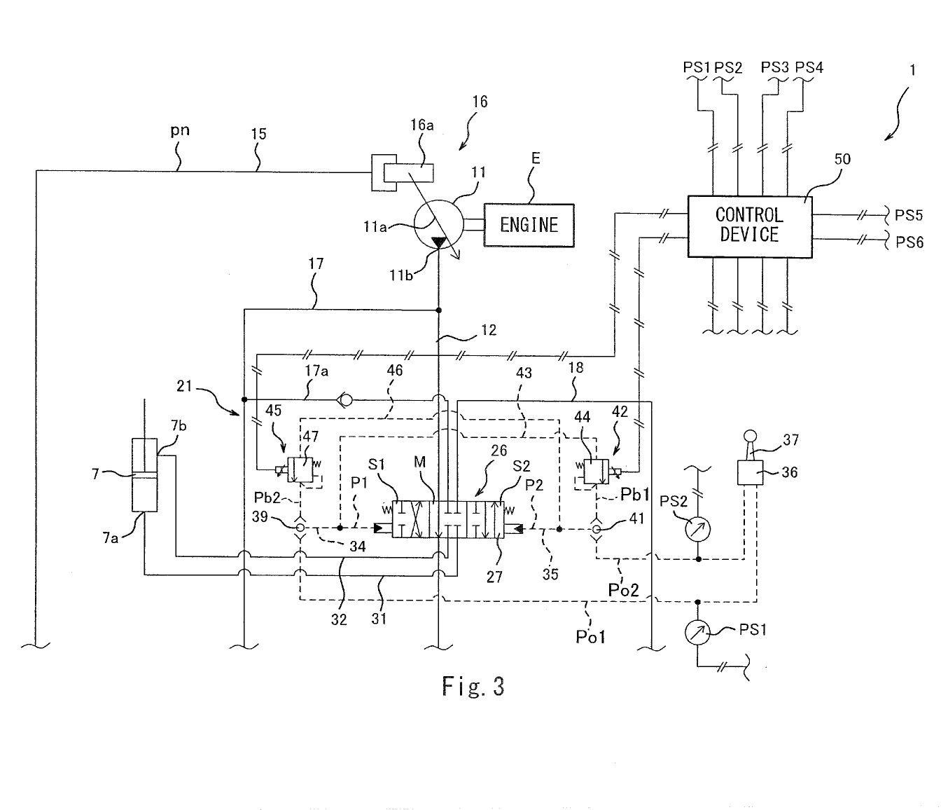

The hydraulic excavator 2 configured as above includes a liquid-pressure control device 1 configured to supply a pressure liquid to actuators, such as the boom cylinder 7, the arm cylinder 9, and the revolution motor 10, to drive these actuators and has the following operational advantages. Hereinafter, the configuration of the liquid-pressure control device 1 will be explained in reference to FIGS. 2 and 3.

Liquid-Pressure Control Device

The liquid-pressure control device 1 is constituted by a so-called negative control liquid-pressure control circuit and includes a liquid-pressure pump 11. The liquid-pressure pump 11 is coupled to an engine E and is configured to discharge an oil pressure by the rotation of the engine E. A variable displacement liquid-pressure pump including a swash plate 11a is adopted as the liquid-pressure pump 11, and the liquid-pressure pump 11 discharges the oil pressure at a flow rate corresponding to an angle of the swash plate 11a. An outlet port 11b of the liquid-pressure pump 11 configured as above is connected to a main passage 12.

Three valve units 21, 22, and 23 described below are interposed in the main passage 12. Further, at a downstream side of the valve units 21, 22, and 23, a tank 25 is connected to the main passage 12 through a restrictor 24. A relief passage 13 is connected to the main passage 12 so as to bypass the restrictor 24, that is, be connected to a front side and rear side of the restrictor 24, and a relief valve 14 is disposed on the relief passage 13. A negative control passage 15 is connected to a portion of the main passage 12 which is located upstream of the restrictor 24 and downstream of the valve units 21, 22, and 23. The negative control passage 15 is connected to a servo piston mechanism 16 provided at the liquid-pressure pump 11, and the pressure increased by the restrictor 24 is introduced as a negative control pressure Pn through the negative control passage 15 to a servo piston mechanism 16.

The servo piston mechanism 16 includes a servo piston 16a, and the servo piston 16a moves to a position corresponding to the negative control pressure Pn introduced through the negative control passage 15. The servo piston 16a is coupled to the swash plate 11a of the liquid-pressure pump 11, and the swash plate 11a tilts at an angle corresponding to the position of the servo piston 16a. Specifically, when the negative control pressure Pn increases, the swash plate 11a tilts to reduce its angle, and this reduces a discharge flow rate of the liquid-pressure pump 11. When the negative control pressure Pn decreases, the swash plate 11a tilts to increase its angle, and this increases the discharge flow rate of the liquid-pressure pump 11.

A supply passage 17 is connected to the main passage 12, and the oil pressure discharged through the supply passage 17 is supplied to the actuators 7, 9, and 10. The supply passage 17 branches from a portion of the main passage 12 which is located downstream of the liquid-pressure pump 11 and upstream of the valve units 21, 22, and 23. The supply passage 17 branches into three passage portions 17a, 17b, and 17c at its downstream side, and the valve units 21, 22, and 23 are respectively connected to the branched passage portions 17a, 17b, and 17c. The valve units 21, 22, and 23 are connected to a tank passage 18 and are also connected to the tank 25 through the tank passage 18.

Among the valve units 21, 22, and 23, the boom valve unit 21 located at a most upstream side controls the flow direction and flow rate of the pressure liquid flowing to the boom cylinder 7, and the arm valve unit 23 located at a most downstream side controls the flow direction and flow rate of the pressure liquid flowing to the arm cylinder 9. Further, the revolution valve unit 22 located between the valve units 21 and 23 controls the flow direction and flow rate of the pressure liquid flowing to the revolution motor 10 configured to revolve the revolving super structure 5. The valve units 21, 22, and 23 are the same in configuration and functions as one another except that the valve units 21, 22, and 23 respectively drive different actuators. Hereinafter, the configuration of the boom valve unit 21 will be explained in detail. Regarding the configurations of the revolution valve unit 22 and the arm valve unit 23, different points from the configuration of the boom valve unit 21 will be mainly explained. The same reference signs are used for the same components, and a repetition of the same explanation is avoided. Regarding the functions of the revolution valve unit 22 and the arm valve unit 23, different points from the functions of the boom valve unit 21 will be mainly explained, and explanations of the same points as the functions of the boom valve unit 21 are omitted.

Boom Valve Unit

The boom valve unit 21 includes a switching valve 26 configured to control the flow direction and flow rate of the pressure liquid. The supply passage 17, the tank passage 18, a first supply/discharge passage 31, and a second supply/discharge passage 32 are connected to the switching valve 26 that is a flow control valve. The first supply/discharge passage 31 is connected to a head side 7a of the boom cylinder 7, and the second supply/discharge passage 32 is connected to a rod side 7b of the boom cylinder 7. The switching valve 26 includes a spool 27, and the flow direction and flow rate of the pressure liquid change in accordance with the position of the spool 27.

More specifically, the spool 27 is configured to be movable from a neutral position M to a first offset position S1 and a second offset position S2. At the neutral position M, the communication of the main passage 12 is realized, and the communication of each of the supply passage 17, the tank passage 18, the first supply/discharge passage 31, and the second supply/discharge passage 32 is cut off. With this, the supply and discharge of the oil pressure to and from the boom cylinder 7 stop, so that the movement of the boom 6 stops. On the other hand, since the communication of the main passage 12 is realized, the negative control pressure Pn increases, so that the discharge flow rate of the liquid-pressure pump 11 decreases.

When the spool 27 is moved from the neutral position M to the first offset position S1, the supply passage 17 is connected to the first supply/discharge passage 31, and the second supply/discharge passage 32 is connected to the tank passage 18. With this, the pressure liquid is supplied to the head side 7a of the boom cylinder 7, so that the boom cylinder 7 expands, and the boom 6 swings upward. On the other hand, the main passage 12 is narrowed down by the spool 27 to be then cut off. With this, the negative control pressure Pn decreases, so that the discharge flow rate of the liquid-pressure pump 11 increases.

When the spool 27 is moved from the neutral position M to the second offset position S2, the supply passage 17 is connected to the second supply/discharge passage 32, and the first supply/discharge passage 31 is connected to the tank passage 18. With this, the pressure liquid is supplied to the rod side 7b of the boom cylinder 7, so that the boom cylinder 7 contracts, and the boom 6 swings downward. On the other hand, the main passage 12 is narrowed down by the spool 27 to be then cut off. With this, the negative control pressure Pn decreases, so that the discharge flow rate of the liquid-pressure pump 11 increases.

Two pilot pressures P1 and P2 acting against each other are applied to the spool 27 configured to switch as above, and the spool 27 moves to a position corresponding to a differential pressure dp between the pilot pressures P1 and P2. To be specific, the switching valve 26 supplies the pressure liquid to the boom cylinder 7 in a direction and at a flow rate corresponding to the differential pressure dp between the pilot pressures P1 and P2. The pilot pressures P1 and P2 are respectively introduced through a first pilot passage 34 and a second pilot passage 35, and the first pilot passage 34 and the second pilot passage 35 are connected to a manipulation valve 36.

The manipulation valve 36 is provided with a manipulation lever 37 and outputs a liquid pressure corresponding to a manipulation amount of the manipulation lever 37 in a direction corresponding to a manipulation direction of the manipulation lever 37. To be specific, when the manipulation lever 37 is manipulated in a first direction (forward, for example), the manipulation valve 36 outputs to the first pilot passage 34 a first output pressure P01 corresponding to the manipulation amount of the manipulation lever 37. When the manipulation lever 37 is manipulated in a second direction (rearward, for example), the manipulation valve 36 outputs to the second pilot passage 35 a second output pressure P02 corresponding to the manipulation amount of the manipulation lever 37. A first pressure sensor PS1 configured to detect the first output pressure P01 output to the first pilot passage 34 is disposed on the first pilot passage 34, and a first shuttle valve 39 is provided downstream of the first pressure sensor PS1. A second pressure sensor PS2 configured to detect the second output pressure P02 output to the second pilot passage 35 is disposed on the second pilot passage 35, and a second shuttle valve 41 is provided downstream of the second pressure sensor PS2.

A first back pressure output mechanism 42 is provided downstream of the first shuttle valve 39 that is a first selective valve and upstream of the second shuttle valve 41. The first back pressure output mechanism 42 includes a passage 43. The passage 43 is connected to a downstream side of the first shuttle valve 39, and a first electromagnetic proportional control valve 44 is disposed on the passage 43. The first electromagnetic proportional control valve 44 is a so-called normally closed control valve (direct proportional control valve). The first electromagnetic proportional control valve 44 adjusts a liquid pressure (first pilot pressure P1), introduced from the first pilot passage 34 as a pressure source, to generate a first back pressure pb1 and outputs the first back pressure pb1 to the second shuttle valve 41. The second shuttle valve 41 selects a higher one of the first back pressure pb1 and the second output pressure P02 and supplies the selected liquid pressure as a second pilot pressure P2 to the spool 27.

A second back pressure output mechanism 45 is provided downstream of the second shuttle valve 41 that is a second selective valve and upstream of the first shuttle valve 39, and the second back pressure output mechanism 45 includes a passage 46. The passage 46 is connected to a downstream side of the second shuttle valve 41, and a second electromagnetic proportional control valve 47 is disposed on the passage 46. The second electromagnetic proportional control valve 47 adjusts a liquid pressure (second pilot pressure P2), introduced from the second pilot passage 35 as the pressure source, to generate a second back pressure pb2 and outputs the second back pressure pb2 to the first shuttle valve 39. The first shuttle valve 39 selects a higher one of the second back pressure pb2 and the first output pressure P01 and supplies the selected liquid pressure as the first pilot pressure P1 to the spool 27.

The back pressure output mechanisms 42 and 45 configured as above include a control device 50, and the control device 50 is electrically connected to two electromagnetic proportional control valves 44 and 47. The control device 50 supplies currents (command signals) to the electromagnetic proportional control valves 44 and 47. The electromagnetic proportional control valve 44 adjusts the first back pressure pb1 to generate a pressure corresponding to the supplied current, and the electromagnetic proportional control valve 47 adjusts the second back pressure pb2 to generate a pressure corresponding to the supplied current.

The control device 50 is electrically connected to the first pressure sensor PS1 and the second pressure sensor PS2 and obtains the first output pressure P01 and the second output pressure P02. The control device 50 detects a manipulation state (a manipulation amount and a manipulation direction) of the manipulation lever 37 based on the obtained first output pressure P01 and the obtained second output pressure P02. The control device 50 determines the currents, supplied to the electromagnetic proportional control valves 44 and 47, in accordance with the manipulation state and an operating condition (predetermined operation state) of the liquid-pressure control device 1. Details of a method of determining the currents will be described later. Examples of the predetermined operation state include: the operation states of the valve units 22 and 23 (i.e., the manipulation states of the manipulation levers 37 of the valve units 22 and 23); the revolution of the engine E; an oil temperature; a load acting on the actuator. The revolution of the engine E, the oil temperature, and the load acting on the actuator are detected by sensors not shown. Hereinafter, the functions of the back pressure output mechanisms 42 and 45 configured as above will be explained.

When the first output pressure is output by manipulating the manipulation lever 37, the first output pressure is introduced as the first pilot pressure P1 to the downstream side of the first shuttle valve 39. With this, the spool 27 is pushed toward the first offset position S1 by the first pilot pressure P1. The first pilot pressure P1 is introduced through the passage 43 to the first electromagnetic proportional control valve 44, and the first electromagnetic proportional control valve 44 utilizes the first pilot pressure P1 as the pressure source to output the first back pressure pb1 corresponding to the command signal from the control device 50. Since the second output pressure P02 is not output from the manipulation valve 36, the second shuttle valve 41 selects the first back pressure pb1 as the second pilot pressure P2 to apply the second pilot pressure P2 to the spool 27.

As above, by applying the second pilot pressure P2 to the spool 27, the spool 27 pushed toward the first offset position S1 can be pushed back toward the neutral position M by the second pilot pressure P2. With this, an opening degree between the supply passage 17 and the first supply/discharge passage 31 is reduced, so that the flow rate of the liquid pressure introduced to the head side 7a of the boom cylinder 7 can be restricted. The higher the first back pressure pb1 is, the more the spool 27 is pushed back toward the neutral position M. The opening degree is reduced in accordance with the pushed-back amount, so that the flow rate of the pressure liquid introduced to the head side 7a of the boom cylinder 7 is restricted. To be specific, by adjusting the current flowing from the control device 50 to the first electromagnetic proportional control valve 44, the flow rate of the pressure liquid introduced to the head side 7a of the boom cylinder 7 can be adjusted without changing the manipulation amount of the manipulation lever 37. The control device 50 adjusts the current, supplied to the first electromagnetic proportional control valve 44, in accordance with the satisfied operating condition to adjust the flow rate of the pressure liquid introduced to the head side 7a.

On the other hand, when the second output pressure is output by manipulating the manipulation lever 37, the second output pressure is introduced as the second pilot pressure P2 to the downstream side of the second shuttle valve 41. With this, the spool 27 is pushed toward the second offset position S2 by the second pilot pressure P2. As with the above case, the second back pressure pb2 is output from the second back pressure output mechanism 45. The first shuttle valve 39 selects the second back pressure pb2 as the first pilot pressure P1 to apply the first pilot pressure P1 to the spool 27. With this, the spool 27 pushed toward the first offset position S2 can be pushed back toward the neutral position M. With this, the opening degree between the supply passage 17 and the second supply/discharge passage 32 is reduced, so that the flow rate of the pressure liquid introduced to the rod side 7b of the boom cylinder 7 can be restricted. The higher the second back pressure pb2 is, the more the spool 27 is pushed back toward the neutral position M. The opening degree is reduced in accordance with the pushed-back amount, so that the flow rate of the oil pressure introduced to the rod side 7b of the boom cylinder 7 is restricted. To be specific, by adjusting the current flowing from the control device 50 to the second electromagnetic proportional control valve 47, the flow rate of the pressure liquid introduced to the rod side 7b of the boom cylinder 7 can be adjusted without changing the manipulation amount of the manipulation lever 37. The control device 50 adjusts the current, supplied to the second electromagnetic proportional control valve 47, in accordance with the satisfied operating condition to adjust the flow rate of the pressure liquid introduced to the rod side 7b.

Regarding the back pressure output mechanisms 42 and 45 having such functions, the control device 50 determines whether or not a predetermined operating condition is satisfied. For example, when the control device 50 determines that the oil temperature detected by an oil temperature sensor satisfies the predetermined operating condition (specifically, not lower than a first predetermined temperature), the control device 50 supplies the currents to the electromagnetic proportional control valves 44 and 47 to prevent the oil pressure from easily flowing to the boom cylinder 7. The currents supplied from the control device 50 to the electromagnetic proportional control valves 44 and 47 are adjusted in accordance with output pressures P01 and P02 output from the manipulation valve 36. When the output pressures P01 and P02 are high, the supplied currents are set to be high, so that the restricted flow rate is increased. When the output pressures P01 and P02 are low, the supplied currents are set to be low, so that the restricted flow rate is low. By restricting the flow rate as above, an impact caused when a large amount of pressure liquid is supplied to the boom cylinder 7 at the time of the start-up of the boom 6 under the high-temperature environment where the viscosity is low can be eased.

In contrast, when the control device 50 determines that the oil temperature detected by the oil temperature sensor does not satisfy a different operating condition (specifically, not lower than a second predetermined temperature (<the first predetermined temperature)), the control device 50 supplies to each of the electromagnetic proportional control valves 44 and 47 a current lower than the current supplied when the first predetermined temperature is satisfied, to allow the pressure liquid to easily flow from the boom valve unit 21 to the boom cylinder 7. With this, the amount of pressure liquid supplied to the boom cylinder 7 at the time of the start-up of the boom 6 under the low-temperature environment where the viscosity is high becomes small, so that the slowness of the operation of the boom 6 can be prevented.

Revolution Valve Unit

In the revolution valve unit 22, the first supply/discharge passage 31 and the second supply/discharge passage 32 are connected to the revolution motor 10. The revolution motor 10 is a so-called liquid-pressure motor and includes two ports 10a and 10b. The revolution motor 10 rotates normally or reversely in accordance with the pressure liquid supplied through the ports 10a and 10b. The first supply/discharge passage 31 is connected to the first port 10a, and the second supply/discharge passage 32 is connected to the second port 10b.

In the revolution valve unit 22 configured as above, when the spool 27 is located at the neutral position M, the revolution motor 10, the first supply/discharge passage 31, the second supply/discharge passage 32, a relief valve 48, and a check valve 49 constitutes a closed circuit. At this time, the revolving super structure 5 revolves by inertia, so that brake torque is generated by the revolution motor 10. Thus, while the brake torque is adjusted by the relief valve 48, the revolving super structure 5 stops revolving. When the spool 27 is located at the first offset position S1, the revolution motor 10 normally rotates, so that the revolving super structure 5 revolves. When the spool 27 is located at the second offset position S2, the revolution motor 10 reversely rotates, so that the revolving super structure 5 revolves.

In the revolution valve unit 22, the first back pressure output mechanism 42 can restrict the flow rate of the pressure liquid flowing to the first port 10a of the revolution motor 10, and the second back pressure output mechanism 45 can restrict the flow rate of the pressure liquid flowing to the second port 10b. With this, as with the case of the boom cylinder 7, the impact and slowness of the revolution motor 10 at the time of an initial operation can be reduced. In addition, a large amount of pressure liquid can be prevented from flowing to the revolution motor 10 at the time of the start-up. Thus, energy saving can be achieved.

Further, in the revolution valve unit 22, a third pressure sensor PS3 configured to detect the first output pressure P01 output to the first pilot passage 34 is disposed on the first pilot passage 34, and a fourth pressure sensor PS4 configured to detect the second output pressure P02 output to the second pilot passage 35 is disposed on the second pilot passage 35. The third pressure sensor PS3 is provided upstream of the first shuttle valve 39, and the fourth pressure sensor PS4 is provided upstream of the second shuttle valve 41. The third pressure sensor PS3 and the fourth pressure sensor PS4 are electrically connected to the control device 50, and the control device 50 obtains the first output pressure P01 and the second output pressure P02 from the third pressure sensor PS3 and the fourth pressure sensor PS4.

In the revolution valve unit 22 configured as above, the control device 50 detects the manipulation state of the manipulation lever 37 based on the first output pressure P01 and the second output pressure P02 obtained from the third pressure sensor PS3 and the fourth pressure sensor PS4 and determines the currents, supplied to the electromagnetic proportional control valves 44 and 47, in accordance with the manipulation state and the operating condition of the liquid-pressure control device 1. Therefore, by adjusting the currents supplied from the control device 50 to the electromagnetic proportional control valves 44 and 47, the flow rate of the pressure liquid introduced to the revolution motor 10 can be adjusted without changing the manipulation amount of the manipulation lever 37.

Arm Valve Unit

In the arm valve unit 23, the first supply/discharge passage 31 and the second supply/discharge passage 32 are respectively connected to a head side 9a and rod side 9b of the arm cylinder 9. When the pressure liquid is supplied to the head side 9a, the arm cylinder 9 expands. When the pressure liquid is supplied to the rod side 9b, the arm cylinder 9 contracts.

When the spool 27 is located at the neutral position M, the arm valve unit 23 connected to the arm cylinder 9 as above stops the supply and discharge of the pressure liquid to and from the arm cylinder 9 to stop the movement of the arm 8. When the spool 27 is located at the first offset position S1, the arm valve unit 23 supplies the pressure liquid to the head side 9a of the arm cylinder 9 to cause the arm 8 to swing rearward (toward a pull side). When the spool 27 is located at the second offset position S2, the arm valve unit 23 supplies the pressure liquid to the rod side 9b of the arm cylinder 9 to cause the arm 8 to swing forward (toward a push side).

In the arm valve unit 23, the first back pressure output mechanism 42 can restrict the flow rate of the pressure liquid flowing to the head side 9a of the arm cylinder 9, and the second back pressure output mechanism 45 can restrict the flow rate of the pressure liquid flowing to the rod side 9b of the arm cylinder 9. With this, as with the case of the boom cylinder 7, the impact and slowness of the arm cylinder 9 at the time of the start-up can be reduced.

Further, in the atm valve unit 23, a fifth pressure sensor PS5 configured to detect the first output pressure P01 output to the first pilot passage 34 is disposed on the first pilot passage 34, and a sixth pressure sensor pS6 configured to detect the second output pressure P02 output to the second pilot passage 35 is disposed on the second pilot passage 35. The fifth pressure sensor PS5 is provided upstream of the first shuttle valve 39, and the sixth pressure sensor PS6 is provided upstream of the second shuttle valve 41. The fifth pressure sensor PS5 and the sixth pressure sensor PS6 are electrically connected to the control device 50, and the control device 50 obtains the first output pressure P01 and the second output pressure P02 from the fifth pressure sensor PS5 and the sixth pressure sensor PS6.

In the arm valve unit 23 configured as above, the control device 50 detects the manipulation state of the manipulation lever 37 based on the first output pressure P01 and the second output pressure P02 obtained from the fifth pressure sensor PS5 and the sixth pressure sensor PS6 and determines the currents, supplied to the electromagnetic proportional control valves 44 and 47, in accordance with the manipulation state and the operating condition of the liquid-pressure control device 1. Therefore, by adjusting the currents supplied from the control device 50 to the electromagnetic proportional control valves 44 and 47, the flow rate of the pressure liquid introduced to the arm cylinder 9 can be adjusted without changing the manipulation amount of the manipulation lever 37.

Functions of Liquid-Pressure Control Device

In the liquid-pressure control device 1, when the manipulation lever 37 of the valve unit 21, 22, or 23 is manipulated as above, the output pressure P01 and the output pressure P02 corresponding to the manipulation direction of the manipulation lever 37 are output from the manipulation valve 36, and the spool 27 moves in accordance with the output pressure P01 and the output pressure P02. Thus, the liquid pressure is supplied to the actuator 7, 9, or 10, so that the actuator 7, 9, or 10 operates. When the manipulation levers 37 are individually manipulated, the currents do not basically flow from the control device 50 to the electromagnetic proportional control valves 44 and 47 except for the start-up described as above. To be specific, in each of the valve units 21, 22, and 23, the flow rate of the oil pressure is not restricted by the first back pressure output mechanism 42 and the second back pressure output mechanism 45. On the other hand, in a case where the manipulation lever 37 of the arm valve unit 23 is manipulated while the manipulation lever 37 of the boom valve unit 21 is manipulated such that the boom 6 is lifted upward, the liquid-pressure control device 1 functions as below.

When the manipulation lever 37 of the boom valve unit 21 is manipulated such that the boom 6 is lifted upward, the first output pressure P01 is output from the manipulation valve 36 of the boom valve unit 21, and the first output pressure is applied as the first pilot pressure P1 through the first shuttle valve 39 to the spool 27. When the manipulation lever 37 of the arm valve unit 23 is manipulated, for example, when the manipulation lever 37 of the arm valve unit 23 is manipulated such that the arm 8 is pulled rearward, the first output pressure P01 is output from the manipulation valve 36 of the arm valve unit 23, and the first output pressure P01 is applied as the first pilot pressure P1 through the first shuttle valve 39 to the spool 27. As above, when the first output pressures P01 are output from the manipulation valves 36, the first output pressure and a fifth output pressure are detected by the first pressure sensor PS1 and the fifth pressure sensor PS5, and the control device 50 determines that the operation of lifting the boom 6 upward and the operation of pulling the arm 8 are executed at the same time.

When the manipulation lever 37 is manipulated such that the arm 8 is pushed forward, the second output pressure P02 is output from the manipulation valve 36 of the arm valve unit 23, and the second output pressure P02 is applied as the second pilot pressure P2 through the second shuttle valve 41 to the spool 27. At this time, the second output pressure P02 is detected by the sixth pressure sensor PS6, and the control device 50 obtains the second output pressure and determines that the operation of lifting the boom 6 upward and the operation of pushing the arm 8 forward are executed at the same time.

When the control device 50 determines that the operating of lifting the boom 6 upward and the operation of pulling the arm 8 are executed at the same time, the control device 50 supplies the current to the first electromagnetic proportional control valve 44 of the arm valve unit 23. The current supplied at this time corresponds to the manipulation amount of the manipulation lever 37 of the arm valve unit 23, and the first back pressure pb1 output from the first electromagnetic proportional control valve 44 is a pressure corresponding to the manipulation lever 37. The first back pressure pb1 output as above is applied as the second pilot pressure P2 through the second shuttle valve 41 to the spool 27. With this, the spool 27 of the arm valve unit 23 is pushed back toward the neutral position M, so that the flow rate of the pressure liquid flowing to the arm cylinder 9 is restricted.

A load at the time of the pulling operation of the arm cylinder 9 is lower than a load at the time of the lifting operation of the boom cylinder 7, and the pressure liquid tends to flow to the arm cylinder 9 whose load is lower. Therefore, by restricting the flow rate of the pressure liquid flowing to the arm cylinder 9, the pressure liquid can be prevented from preferentially flowing to the arm cylinder 9, and as explained below, the pressure liquid corresponding to the manipulation amount of the manipulation lever 37 of the boom valve unit 21 can be supplied to the boom cylinder 7. With this, each of the boom cylinder 7 and the arm cylinder 9 can be moved at a speed substantially corresponding to the manipulation amount of the manipulation lever 37.

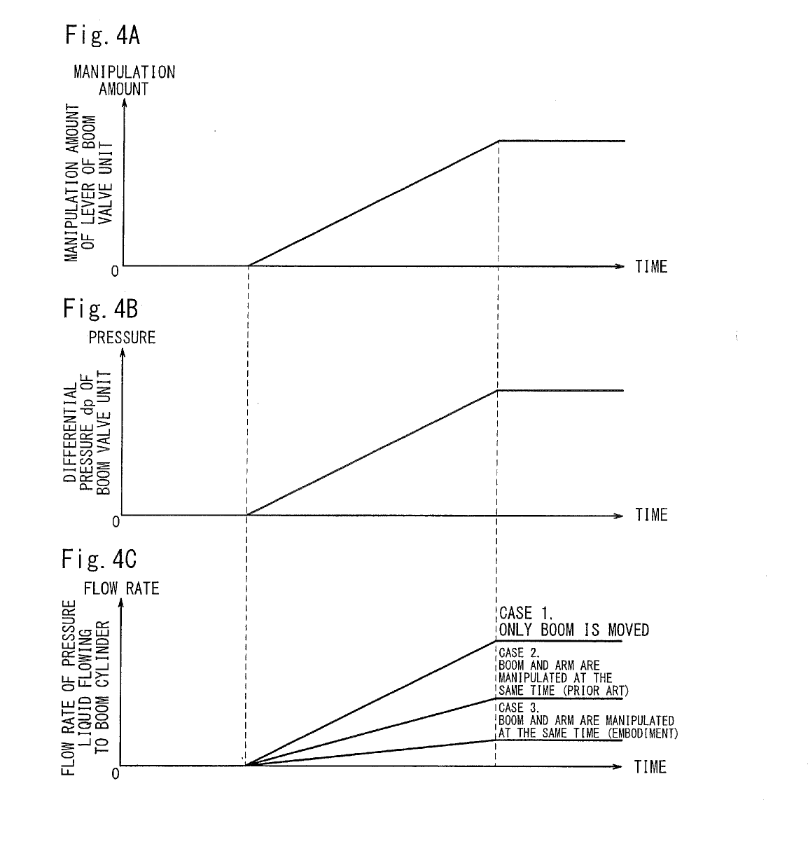

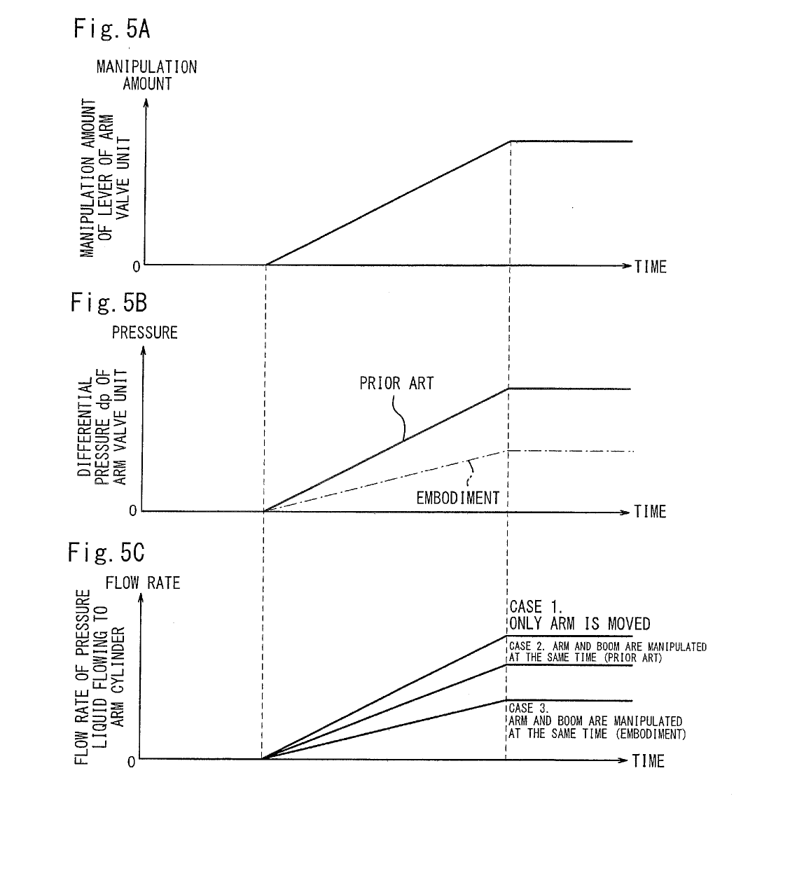

Hereinafter, relations among the manipulation amounts of the manipulation levers 37 and the flow rates of the pressure liquid flowing to the actuators 7 and 9 will be more specifically explained in reference to FIGS. 4 and 5. Vertical axes in FIGS. 4A, 4B, 4C respectively denote the manipulation amount of the manipulation lever 37 of the boom valve unit 21, the differential pressure dp between the pilot pressures acting on the spool of the boom valve unit 21, and the flow rate of the pressure liquid flowing to the boom cylinder 7. Each of horizontal axes in FIGS. 4A, 4B, 4C denotes a time. Vertical axes in FIGS. 5A, 5B, and 5C respectively denote the manipulation amount of the manipulation lever 37 of the arm valve unit 23, the differential pressure dp between the pilot pressures acting on the spool of the arm valve unit 23, and the flow rate of the oil pressure flowing to the arm cylinder 9. Each of horizontal axes in FIGS. 5A, 5B, 5C denotes a time.

In the liquid-pressure control device 1, when the manipulation lever 37 of the boom valve unit 21 is manipulated in one of the manipulation directions (i.e., a right direction in FIG. 2) at a constant speed as shown in FIG. 4A, the first output pressure P01 which increases at a constant speed is output from the manipulation valve 36 of the boom valve unit 21. At this time, the second output pressure P02 is not output from the manipulation valve 36, and the first back pressure pb1 is not output from the first back pressure mechanism. Therefore, an absolute value of the differential pressure dp acting on the spool 27 corresponds to the first pilot pressure P1, and as shown by Case 1 in FIG. 4C, the flow rate of the pressure liquid uniformly increases in accordance with the manipulation amount of the manipulation lever 37.

Simultaneously, when the manipulation lever 37 of the arm valve unit 23 is manipulated in one of the manipulation directions (i.e., the right direction in FIG. 2) at a constant speed as shown in FIG. 5A, the first output pressure P01 which increases at a constant speed is output from the manipulation valve 36 of the arm valve unit 23 to be applied as the first pilot pressure P1 to the spool 27 of the arm valve unit 23. For example, in a case where only the first pilot pressure P1 acts on the spool 27, a pressure against the first pilot pressure P1 does not act on the spool 27. Therefore, the differential pressure dp acting on the spool 27 increases at a constant speed in accordance with the manipulation amount of the manipulation valve 36 of the arm valve unit 23 as shown by solid lines in FIGS. 5A and 5B. With this, since the load of the arm cylinder 9 is smaller than the load of the boom cylinder 7, the pressure liquid preferentially flows to the arm cylinder 9 (see Case 2 in FIG. 4C and Case 2 in FIG. 5C).

Regarding the arm valve unit 23 in the liquid-pressure control device 1, since the first output pressure P01 is introduced to the downstream side of the first shuttle valve 39, the first back pressure pb1 is output from the first back pressure output mechanism 42 to be applied as the second pilot pressure P2 to the spool 27. As described above, the first back pressure pb1 is output in accordance with the currents from the control device 50, and the control device 50 supplies the currents based on a predetermined setting. In the present embodiment, the currents from the control device 50 are set in accordance with the manipulation amount of the manipulation lever 37 of the arm valve unit 23 and are set such that the differential pressure dp acting on the spool 27 becomes a pressure shown by a dashed line in FIG. 5B.

Even in a case where the manipulation lever 37 of the boom valve unit 21 and the manipulation lever 37 of the arm valve unit 23 are manipulated at the same time in the liquid-pressure control device 1, each of the flow rate of the pressure liquid flowing to the boom cylinder 7 and the flow rate of the pressure liquid flowing to the arm cylinder 9 can be made substantially constant by setting the currents as above, so as to correspond to the manipulation amount of the manipulation lever 37 as shown by Case 3 in FIG. 4C or Case 3 in FIG. 5C.

In the liquid-pressure control device 1 functioning as above, the pressure liquid can be supplied to each of the actuators 7, 9, and 10 at the flow rate corresponding to the manipulation amount, so that the operability improves. In addition, in the liquid-pressure control device 1, each of the first back pressure output mechanism 42 and the second back pressure output mechanism 45 can restrict the flow rate of the liquid pressure supplied to the actuator 7, 9, or 10. Each of the first back pressure output mechanism 42 and the second back pressure output mechanism 45 can adjust the restricted flow rate in accordance with the currents supplied from the control device 50 to the electromagnetic proportional control valves 44 and 47. Therefore, the first back pressure pb1 and the second back pressure pb2 can be adjusted only by changing the settings of the currents flowing from the control device 50 to the electromagnetic proportional control valves 44 and 47. Therefore, tuning (work of: preparing a number of spools whose opening areas are different from one another; performing experiments while sequentially replacing the spools; and determining an optimal opening area) in a case where a pilot control valve is adopted is not required, so that a development time of the liquid-pressure control device 1 can be shortened.

The foregoing has explained a case where the manipulation lever 37 of the boom valve unit 21 and the manipulation lever 37 of the arm valve unit 23 are manipulated at the same time. The liquid-pressure control device 1 operates in the same manner as above even in a case where the manipulation lever 37 of the revolution valve unit 22 is manipulated while the manipulation lever 37 of the boom valve unit 21 is manipulated such that the boom 6 is lifted upward. To be specific, when the manipulation lever 37 of the boom valve unit 21 and the manipulation lever 37 of the revolution valve unit 22 are manipulated at the same time, the flow rate of the oil pressure flowing to the revolution motor 10 is restricted, and the same operational advantages as in the case of the arm valve unit 23 are obtained. The details are described above, so that explanations thereof are omitted.

In the liquid-pressure control device 1 configured as above, a normally closed valve is adopted as each of the electromagnetic proportional control valves 44 and 47 of the back pressure output mechanisms 42 and 45. Therefore, even when a failure occurs where the currents cannot be supplied from the control device 50 to the electromagnetic proportional control valves 44 and 47, or even when an operation failure occurs since movable portions of the electromagnetic proportional control valves 44 and 47 are fixed by foreign matters or the like, the spool 27 does not move to an unintended position. Thus, fail-safe is achieved in the liquid-pressure control device 1. The pressure sources of the back pressure output mechanisms 42 and 45 are respectively the output pressures P01 and P02 of the manipulation valve 36. Therefore, in a neutral state where the manipulation lever 37 of the manipulation valve 36 is not manipulated, the spool 27 does not move even if the electromagnetic proportional control valves 44 and 47 malfunction. In this respect, the fail-safe is achieved in the liquid-pressure control device 1.

Further, the pressure sources of the electromagnetic proportional control valves 44 and 47 are the first pilot pressure P1 and the second pilot pressure P2. The electromagnetic proportional control valves 44 and 47 are configured such that the first back pressure pb1 and the second back pressure pb2 output therefrom respectively become lower than the first pilot pressure P1 and the second pilot pressure P2. To be specific, a maximum opening degree of each of the electromagnetic proportional control valves 44 and 47 is set to lower than 100%, for example, not higher than 70%, preferably not higher than 50%. With this, even in a case where each of the electromagnetic proportional control valves 44 and 47 keeps on operating at the maximum opening degree by the failure of each of the electromagnetic proportional control valves 44 and 47, the spool 27 can be moved from the neutral position M to a certain position located at the offset position S1 side or the offset position S2 side, so that the liquid pressure can be supplied to the actuator 7, 9, or 10. Thus, it is possible to prevent a case where the liquid-pressure control device 1 does not operate by the failures of the electromagnetic proportional control valves 44 and 47 or the failure of the control device 50.

### Embodiment 2

The liquid-pressure control device 1A of Embodiment 2 is similar in configuration to the liquid-pressure control device 1 of Embodiment 1. Hereinafter, regarding the configuration of the liquid-pressure control device 1A of Embodiment 2, points different from the liquid-pressure control device 1 of Embodiment 1 will be mainly explained. The same reference signs are used for the same components, and explanations thereof may be omitted. The same is true for the liquid-pressure control devices 1B and 1C of Embodiments 3 and 4.

The liquid-pressure control device 1A is constituted by a positive control liquid-pressure control circuit, and a main passage 12A is directly connected to the tank 25 without through the restrictor 24. In the liquid-pressure control device 1A, a pilot pump not shown is connected to the servo piston mechanism 16 through a positive control passage 15A, and an electromagnetic valve 19 is interposed in the positive control passage 15A.

The electromagnetic valve 19 is an electromagnetic control valve. The electromagnetic valve 19 reduces the liquid pressure, discharged from a pilot pump not shown, to a pressure corresponding to the current flowing through the electromagnetic valve 19 and outputs the pressure as a positive control pressure pₚ. The positive control pressure pₚ output as above is introduced to the servo piston mechanism 16, and the servo piston 16a moves to a position corresponding to the positive control pressure pₚ. With this, the swash plate 11a tilt at an angle corresponding to the positive control pressure pₚ.

The electromagnetic valve 19 configured as above is connected to the control device 50, and the control device 50 determines the current supplied to the electromagnetic valve 19 based on the output pressure obtained from each of the pressure sensors PS1 to PS6. For example, the control device 50 supplies the current corresponding to the obtained output pressure. That is, when the output pressure is high, the control device 50 supplies to the electromagnetic valve 19 a high current corresponding to the high output pressure. When the output pressure is low, the controller supplies to the electromagnetic valve 19 a low current corresponding to the low output pressure. To be specific, the control device 50 supplies to the electromagnetic valve 19 the current corresponding to the manipulation amount of the manipulation lever 37 and causes the liquid-pressure pump 11 to output the liquid pressure at the flow rate corresponding to the manipulation amount.

The liquid-pressure control device 1A configured as above has the same operational advantages as the liquid-pressure control device 1 of Embodiment 1 except for operational advantages obtained since the positive control liquid-pressure control circuit is adopted.

### Embodiment 3

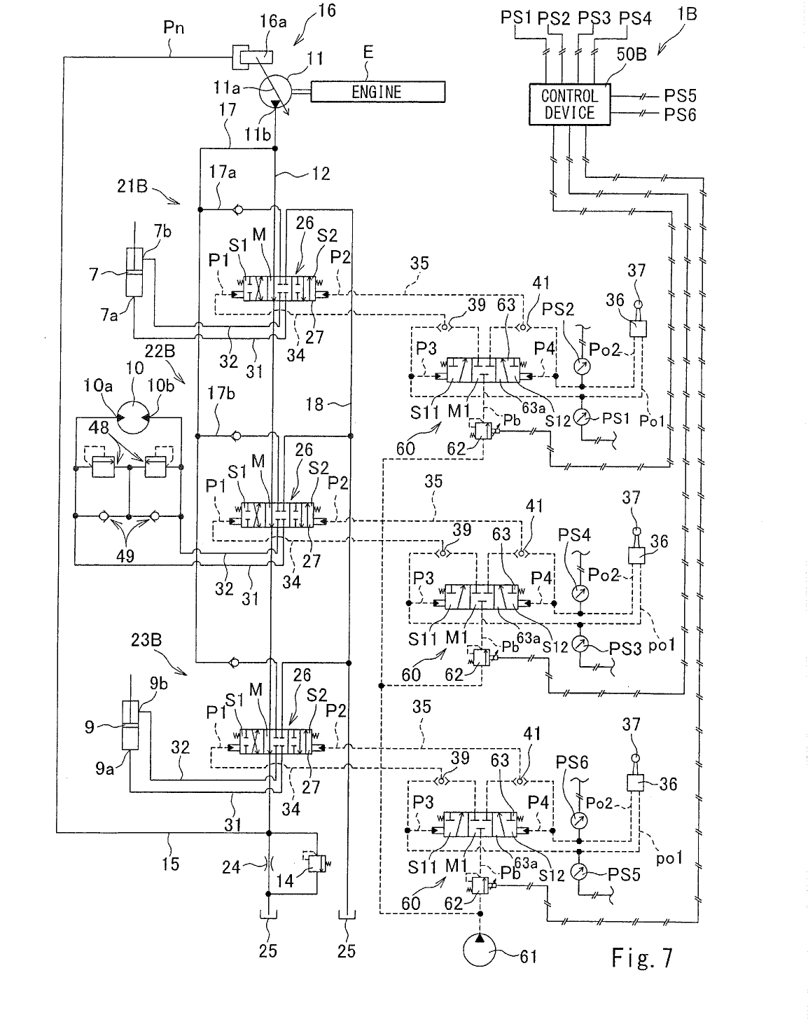

The liquid-pressure control device 1B of Embodiment 3 includes three valve units 21B, 22B, and 23B as shown in FIG. 7, and the valve units 21B, 22B, and 23B respectively include back pressure output mechanisms 60. Each of the back pressure output mechanisms 60 is connected to the first shuttle valve 39 and the second shuttle valve 41, and the back pressure output mechanisms 60 are connected in parallel to a pilot pump 61 included in the liquid-pressure control device 1B. The pilot pump 61 is a fixed displacement liquid-pressure pump and supplies a fixed amount of pressure liquid to the back pressure output mechanism 60.

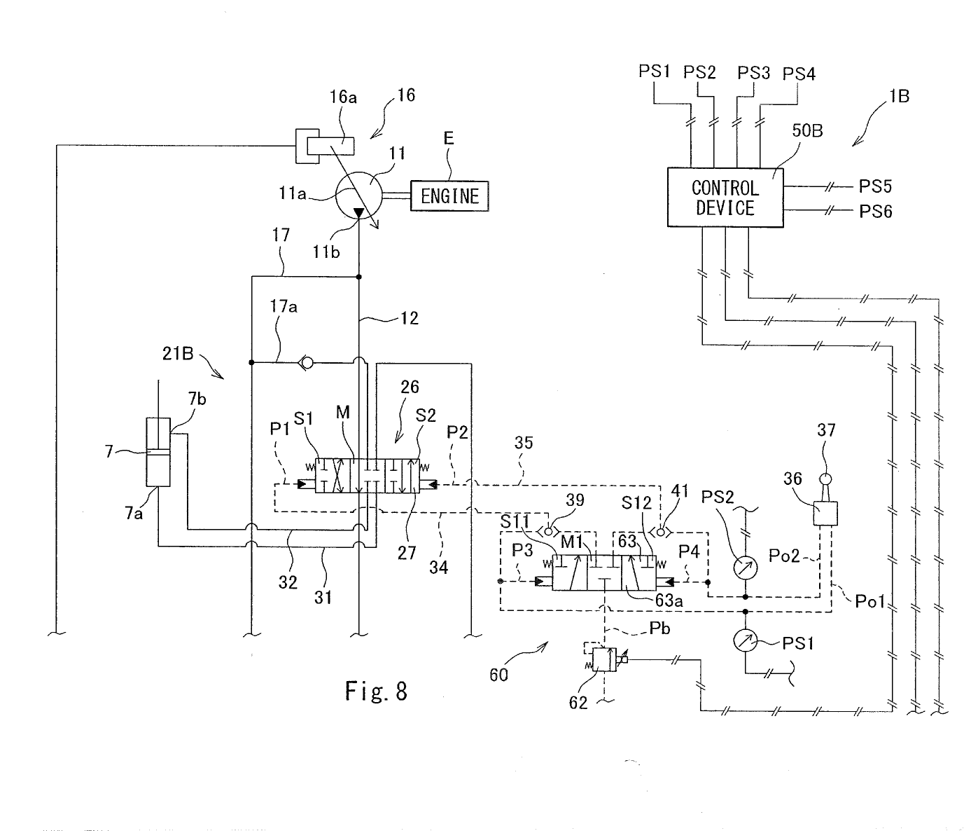

As shown in FIG. 8, the back pressure output mechanism 60 includes an electromagnetic proportional control valve 62 and a back pressure switching valve 63. The electromagnetic proportional control valve 62 is a so-called normally closed direct proportional control valve. The electromagnetic proportional control valve 62 utilizes a discharge pressure of the pilot pump 61 as the pressure source and reduces and adjusts the pressure of the pressure liquid, discharged from the pilot pump 61, to generate a back pressure p_{b}. The electromagnetic proportional control valve 62 is connected to the back pressure switching valve 63 and outputs the adjusted back pressure p_{b} to the back pressure switching valve 63.

The back pressure switching valve 63 includes a spool 63a and switches the flow direction of the pressure liquid, output from the electromagnetic proportional control valve 62, in accordance with the position of the spool 63a. More specifically, the back pressure switching valve 63 is connected to one of input ports of the first shuttle valve 39 and one of input ports of the second shuttle valve 41, and the spool 63a is configured to be movable from the neutral position M1 to a first offset position S11 and a second offset position S12. When the spool 63a moves from the neutral position M1 toward the first offset position S11, an output port of the electromagnetic proportional control valve 62 and the input port of the second shuttle valve 41 is connected to each other through the back pressure switching valve 63, and the back pressure p_{b} is introduced to the input port of the second shuttle valve 41. In contrast, when the spool 63a moves from the neutral position M1 toward the second offset position S12, the output port of the electromagnetic proportional control valve 62 and the input port of the first shuttle valve 39 are connected to each other through the back pressure switching valve 63, and the back pressure p_{b} is introduced to the input port of the first shuttle valve 39. When the spool 63a returns to the neutral position M1, the communication between the output port of the electromagnetic proportional control valve 62 and the input port of the first shuttle valve 39 and the communication between the output port of the electromagnetic proportional control valve 62 and the input port of the second shuttle valve 41 are cut off.

The spool 63a configured to move as above receives two pilot pressures p₃ and p₄ acting against each other and moves to a position corresponding to the differential pressure between the pilot pressures p₃ and p₄. With this, the back pressure switching valve 63 supplies the pressure liquid from the electromagnetic proportional control valve 62 in a direction corresponding to the differential pressure between the pilot pressures p₃ and p₄.

In the back pressure output mechanism 60 configured as above, when the first output pressure P01 is output from the manipulation valve 36 by manipulating the manipulation lever 37 in the first direction, the first output pressure P01 is input as the third pilot pressure p₃ to the spool 63a. At this time, only the first output pressure P01 is output from the manipulation valve 36, and the fourth pilot pressure p₄ is substantially zero. Therefore, the spool 63a moves toward the first offset position S11, and the output port of the electromagnetic proportional control valve 62 is connected to the input port of the second shuttle valve 41 through the back pressure switching valve 63. With this, the back pressure p_{b} output from the electromagnetic proportional control valve 62 is introduced to the input port of the second shuttle valve 41 through the back pressure switching valve 63.

The second shuttle valve 41 selects a higher one of the second output pressure P02 and the back pressure p_{b}. Since the second output pressure P02 is substantially zero, the second shuttle valve 41 selects the back pressure p_{b}. The selected back pressure p_{b} is applied as the second pilot pressure P2 to the spool 27 of a directional control valve 26. When the spool 63a moves to the first offset position S11, the communication between the output port of the electromagnetic proportional control valve 62 and the input port of the first shuttle valve 39 is cut off. Therefore, the first output pressure P01 is selected to be applied as the first pilot pressure P1 to the spool 27 of the directional control valve 26.

In contrast, when the second output pressure P02 is output from the manipulation valve 36 by manipulating the manipulation lever 37 in the second direction, the second output pressure P02 is introduced as the fourth pilot pressure p₄ to the spool 63a. At this time, the third pilot pressure p₃ is substantially zero, so that the spool 63a moves toward the second offset position S12, and the output port of the electromagnetic proportional control valve 62 is connected to the input port of the first shuttle valve 39 through the back pressure switching valve 63. By this connection, the back pressure p_{b} from the electromagnetic proportional control valve 62 is introduced to the input port of the first shuttle valve 39 through the back pressure switching valve 63. Then, the first shuttle valve 39 selects the back pressure p_{b}, and the back pressure p_{b} is applied as the first pilot pressure P1 to the spool 27 of the directional control valve 26. The second shuttle valve 41 selects the second output pressure P02, and the second output pressure P02 is applied as the second pilot pressure P2 to the spool 27 of the directional control valve 26.

As above, in the back pressure output mechanism 60, the back pressure p_{b} against the output pressure P01 or P02 from the manipulation valve 36 is applied to the spool 27, so that the flow rate of the liquid pressure to the actuator 7, 9, or 10 is restricted. The restricted flow rate is determined in accordance with the back pressure p_{b}. To adjust the back pressure p_{b}, the back pressure output mechanism 60 includes a control device 50B.

The control device 50B supplies the current to the electromagnetic proportional control valve 62 and controls the supplied current to adjust the back pressure p_{b}. More specifically, the control device 50B controls the current, supplied to the electromagnetic proportional control valve 62, in accordance with the satisfied operating condition and causes the electromagnetic proportional control valve 62 to output the back pressure p_{b} corresponding to the satisfied operating condition. With this, as with the liquid-pressure control device 1 of Embodiment 1, the flow rate of the pressure liquid flowing to each of the actuators 7, 9, and 10 can be restricted in accordance with the operating condition.

In the liquid-pressure control device 1B configured as above, since the back pressure switching valve 63 is provided, an electromagnetic proportional control valve for adjusting the back pressure p_{b} does not have to be provided at each of the first pilot pressure side and the second pilot pressure side. With this, the number of electromagnetic proportional control valves 62 in the valve units 21B, 22B, and 23B can be reduced, and the manufacturing cost of the liquid-pressure control device 1B can be reduced.

Other than the above, the liquid-pressure control device 1B of Embodiment 3 has the same operational advantages as the liquid-pressure control device 1 of Embodiment 1.

### Embodiment 4

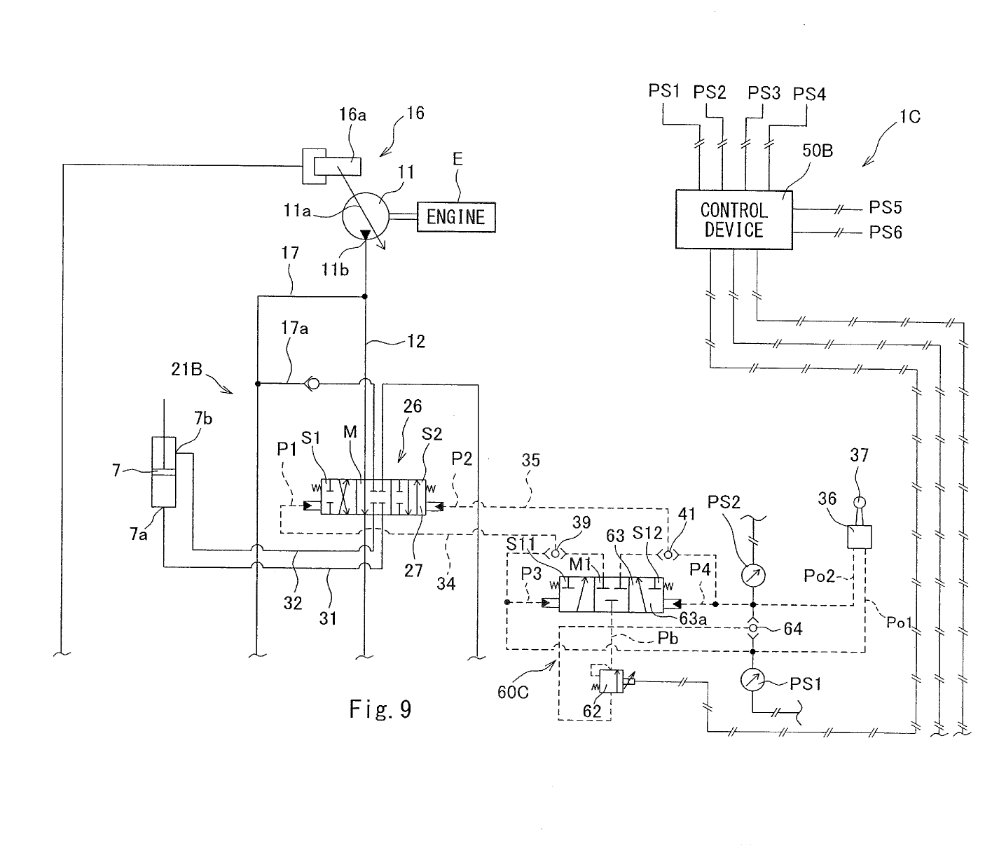

The liquid-pressure control device 1C of Embodiment 4 is similar in configuration to the liquid-pressure control device 1B of Embodiment 3 but is different from the liquid-pressure control device 1B of Embodiment 3 in that the electromagnetic proportional control valve 62 utilizes as the pressure sources the output pressures P01 and P02 output from the manipulation valve 36. More specifically, as shown in FIG. 9, a back pressure output mechanism 60C of the liquid-pressure control device 1C includes a third shuttle valve 64, and the third shuttle valve 64 supplies a higher one of the first output pressure P01 and second output pressure P02 of the manipulation valve 36 to the electromagnetic proportional control valve 62.

In the liquid-pressure control device 1C configured as above, the pressure sources of the electromagnetic proportional control valve 62 are the output pressures P01 and P02 of the manipulation valve 36. Therefore, in a neutral state where the manipulation lever 37 of the manipulation valve 36 is not manipulated, the spool 27 does not move even if the electromagnetic proportional control valve 62 malfunctions. In this respect, the fail-safe is achieved in the liquid-pressure control device 1C.

Other than the above, the liquid-pressure control device 1C of Embodiment 4 has the same operational advantages as the liquid-pressure control device 1B of Embodiment 3.

### Other Embodiments

In each of the liquid-pressure control devices 1 and 1A of Embodiments 1 and 2, the pressure sources of the first back pressure output mechanism 42 and the second back pressure output mechanism 45 are respectively the output pressure P01 and output pressure P02 of the manipulation valve 36 but do not have to be the output pressure P01 and output pressure P02 of the manipulation valve 36. For example, a pilot pump configured to supply the pressure liquid to the manipulation valve 36 may be directly connected to an inlet of the first back pressure output mechanism 42 and an inlet of the second back pressure output mechanism 45 to be utilized as the pressure source. Both the first back pressure output mechanism 42 and the second back pressure output mechanism 45 do not have to be provided, and only one of the first back pressure output mechanism 42 and the second back pressure output mechanism 45 may be included. Further, it is preferable that the electromagnetic proportional control valves 44 and 47 be normally closed valves. However, the electromagnetic proportional control valves 44 and 47 may be normally open electromagnetic inverse proportional control valves (electromagnetic proportional control valves whose output pressure decreases as the current increases).

Each of the actuators 7, 9, and 10 driven by the liquid-pressure control devices 1 and 1A to 1C of Embodiments 1 to 4 is not limited to the above and may be a bucket cylinder, a steering cylinder, or a motor for travel driving. The liquid-pressure pump 11 does not have to be a variable displacement pump and may be a fixed displacement pump. Further, the pressure liquid to be used is not limited to oil and may be water or the other liquid.

Each of the liquid-pressure control devices 1 and 1A to 1C of Embodiments 1 to 4 is applied to the negative control liquid-pressure control circuit. However, the present invention is not limited to the negative control liquid-pressure control circuit, and each of the liquid-pressure control devices 1 and 1A to 1C of Embodiments 1 to 4 may be applied to the positive control liquid-pressure control circuit. Each of the liquid-pressure control devices 1 and 1A to 1C of Embodiments 1 to 4 is applicable to each of all types of liquid-pressure control circuits each including a control valve using a spool.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

### REFERENCE SIGNS LIST

1, 1A to 1C liquid-pressure control device
2 hydraulic excavator
7 boom cylinder
9 arm cylinder
10 revolution motor
11 liquid-pressure pump
16 servo piston mechanism
21 boom valve unit
22 revolution valve unit
23 arm valve unit
26 switching valve
27 spool
36 manipulation valve
37 manipulation lever
39 first shuttle valve
41 second shuttle valve
42 first back pressure output mechanism
44 first electromagnetic proportional control valve
45 second back pressure output mechanism
47 second electromagnetic proportional control valve
50, 50B control device
60 back pressure output mechanism
61 pilot pump
62 electromagnetic proportional control valve
63 back pressure switching valve
64 third shuttle valve

1. A liquid-pressure control device configured to supply a pressure liquid, discharged from a liquid-pressure pump driven by an engine or an electric motor, to an actuator to drive the actuator,
the liquid-pressure control device comprising:
a manipulation valve including a manipulation lever and configured to output an output pressure corresponding to a manipulation amount of the manipulation lever when the manipulation lever is manipulated;
a back pressure output mechanism configured to output a back pressure when a predetermined operation state is satisfied; and
a flow control valve to which the output pressure output from the manipulation valve is input as a first pilot pressure and the back pressure is input as a second pilot pressure, the flow control valve being configured to supply the pressure liquid to the actuator at a flow rate corresponding to a differential pressure between the first pilot pressure and the second pilot pressure.

2. The liquid-pressure control device according to claim 1, wherein:
the operation state includes at least one of a manipulation state of the manipulation lever, a revolution of the engine, a temperature of the pressure liquid, and a load acting on the actuator; and
the back pressure output mechanism outputs the back pressure corresponding to the operation state.

3. The liquid-pressure control device according to claim 2, wherein:
a set of the flow control valve and the manipulation valve is provided for each of a plurality of actuators including the actuator; and
the manipulation state of the manipulation lever includes a state where at least two of the manipulation levers of the manipulation valves are manipulated.

4. The liquid-pressure control device according to claim 2, wherein:
the back pressure output mechanism includes a control device and an electromagnetic control valve;
the control device outputs to the electromagnetic control valve a command signal corresponding to the operation state; and
the electromagnetic control valve outputs the back pressure corresponding to the command signal.

5. The liquid-pressure control device according to claim 4, wherein the electromagnetic control valve is a normally closed valve.

6. The liquid-pressure control device according to claim 1, further comprising a high pressure selective valve configured to select a higher one of two input pressures to output the selected input pressure as the second pilot pressure to the flow control valve, wherein:
the manipulation valve outputs a first output pressure and a second output pressure, which correspond to the manipulation amount of the manipulation lever, as the output pressure in accordance with a manipulation direction of the manipulation lever;
the first output pressure is input as the first pilot pressure to the flow control valve; and
the second output pressure and the back pressure are input as the two input pressures to the high pressure selective valve.

7. The liquid-pressure control device according to claim 1, wherein the back pressure output mechanism utilizes the first output pressure as a pressure source and reduces the first output pressure to generate the back pressure.

8. The liquid-pressure control device according to claim 4, further comprising a back pressure switching valve configured to input the back pressure, output from the electromagnetic control valve, to the flow control valve as one of the first pilot pressure and the second pilot pressure, wherein:
the manipulation valve outputs one of the first output pressure and the second output pressure as the output pressure in accordance with a manipulation direction of the manipulation lever;
the first output pressure is input as the first pilot pressure to the flow control valve;
the second output pressure is input as the second pilot pressure to the flow control valve;
when the first output pressure is output from the manipulation valve, the back pressure switching valve inputs the back pressure as the second pilot pressure to the flow control valve; and
when the second output pressure is output from the manipulation valve, the back pressure switching valve inputs the back pressure as the first pilot pressure to a switching valve.

9. The liquid-pressure control device according to claim 8, wherein the electromagnetic control valve reduces a higher one of the first output pressure and the second output pressure to generate the back pressure.
